(19) United States
(12) Patent Application Publication
(10) Pub. No.: US 2023/0091074 A1
(43) Pub. Date: Mar. 23, 2023

(54) MEDIUM CONVEYANCE DEVICE, CONTROL METHOD, AND CONTROL PROGRAM

(71) Applicant: PFU LIMITED, Kahoku-shi, Ishikawa (JP)

(72) Inventors: Ayame TAKAYAMA, Kahoku-shi (JP); Masaaki SAKAI, Kahoku-sh (JP)

(21) Appl. No.: 17/904,579

(22) PCT Filed: Mar. 2, 2020
(86) PCT No.: PCT/JP2020/008753

§ 371 Date: Aug. 18, 2022

(51) Int. Cl. B65H 7/12

(52) U.S. Cl. CPC B65H 7/125; B65H 2553/30

(57) ABSTRACT

Provided are a medium conveying apparatus, a control method, and a control program to enable more accurate detennination whether a medium conveyance abnormality has occurred. A medium conveying apparatus includes an ultrasonic transmitter capable of outputting an ultrasonic wave, an ultrasonic receiver opposed to the ultrasonic transmitter, to receive the ultrasonic wave and output an ultrasonic signal corresponding to the received ultrasonic wave, a pressure detection module to detect atmospheric pressure, based on the ultrasonic signal, a sound receiver to receive a sound and generate a sound signal corresponding to the received sound, an abnormality determination module to determine whether a medium conveyance abnormality has occurred, based on the sound signal, and a modification module to modify sensitivity of the sound receiver, correct the sound signal, or modify a criterion for determination of a medium conveyance abnormality by the abnormality determination module, based on the atmospheric pressure.

### FIELD

The present disclosure relates to medium conveying apparatuses, control methods, and control programs, and more particularly to a medium conveying apparatus, a control method, and a control program to determine whether a medium conveyance abnormality has occurred.

### BACKGROUND

In a medium conveying apparatus, such as a scanner, a conveyance abnormality, such as a jam or skew of a medium, may occur when a medium moves along a conveyance path. In general, a medium conveying apparatus has the function of determining whether a conveyance abnormality has occurred, based on whether a medium is conveyed to a predetermined position on a conveyance path within a predetermined period of time from the start of conveyance of the medium, and of stopping operation of the apparatus if a conveyance abnormality has occurred. Since a conveyance abnormality causes a large sound in the conveyance path, the medium conveying apparatus may detect the occurrence of a conveyance abnormality before the elapse of the predetermined period, by determining its occurrence based on a sound produced in the conveyance path.

A medium conveying apparatus is disclosed that determines the presence or absence of a multi-feed of a medium, based on the intensity of detected ultrasonic waves and a multi-feed threshold (see Patent Literature I). The apparatus modifies the multi-feed threshold, based on the slopes of two lines respectively representing detected intensity as a function of intensity of ultrasonic waves transmitted from an ultrasonic transmitter at an altitude of 0 m and at an altitude where the apparatus is actually used.

A sheet feeding apparatus is disclosed that determines whether two or more sheets are fed with one overlaid on another, based on a threshold and a signal received from a means for receiving ultrasonic waves opposed to a means for transmitting ultrasonic waves (see Patent Literature 2). The threshold is set based on a first signal outputted from the receiving means when there is no sheet between the transmitting and receiving means and a second signal outputted from the receiving means when there is a sheet therebetween.

### CITATION LIST

### Patent Literature

Patent Literature 1: Japanese Unexamined Patent Publication No. 2019-43693

Patent Literature 2: Japanese Unexamined. Patent Publication No. 2017-39589

### SUMMARY

It is desirable for a medium conveying apparatus to determine whether a medium conveyance abnormality has occurred more accurately.

An object of a medium conveying apparatus, a control method, and a control program is to enable more accurate determination whether a medium conveyance abnormality has occurred.

According to some embodiments, a medium conveying apparatus includes an ultrasonic transmitter capable of outputting an ultrasonic wave, an ultrasonic receiver opposed to the ultrasonic transmitter, to receive the ultrasonic wave and output an ultrasonic signal corresponding to the received ultrasonic wave, a pressure detection module to detect atmospheric pressure, based on the ultrasonic signal, a sound receiver to receive a sound and generate a sound signal corresponding to the received sound, an abnormality determination module to determine whether a medium conveyance abnormality has occurred, based on the sound signal, and a modification module to modify sensitivity of the sound receiver, correct the sound signal, or modify a criterion for determination of a medium conveyance abnormality by the abnormality determination module, based on the atmospheric pressure.

According to some embodiments, a control method of a medium conveying apparatus including an ultrasonic transmitter capable of outputting an ultrasonic wave, an ultrasonic receiver opposed to the ultrasonic transmitter, to receive the ultrasonic wave and output an ultrasonic signal corresponding to the received ultrasonic wave, and a sound receiver to receive a sound and generate a sound signal corresponding to the received sound, includes detecting atmospheric pressure, based on the ultrasonic signal, determining whether a medium conveyance abnormality has occurred, based on the sound signal, and modifying sensitivity of the sound receiver, correcting the sound signal, or modifying a criterion for determination of a medium conveyance abnormality, based on the atmospheric pressure.

According to some embodiments, a control program of a medium conveying apparatus including an ultrasonic transmitter capable of outputting an ultrasonic wave, an ultrasonic receiver opposed to the ultrasonic transmitter, to receive the ultrasonic wave and output an ultrasonic signal corresponding to the received ultrasonic wave, and a sound receiver to receive a sound and generate a sound signal corresponding to the received sound, causes the medium conveying apparatus to execute detecting atmospheric pressure, based on the ultrasonic signal, determining whether a medium conveyance abnormality has occurred, based on the sound signal, and modifying sensitivity of the sound receiver, correcting the sound signal, or modifying a criterion for determination of a medium conveyance abnormality, based on the atmospheric pressure.

The medium conveying apparatus, the control method, and the control program according to the embodiment enable more accurate determination whether a medium conveyance abnormality has occurred.

The object and advantages of the invention will be realized and attained by means of the elements and combinations, in particular, described in the claims. It is to be understood that both the foregoing general description and the following detailed description are exemplary and explanatory, and are not restrictive of the invention, as claimed.

### BRIEF DESCRIPTION OF DRAWINGS

FIG. 1 is a perspective view showing a medium conveying apparatus 100 according to an embodiment.

FIG. 2 is a diagram for explaining a conveyance path inside the medium conveying apparatus 100.

FIG. 3 is a block diagram schematically showing the configuration of the medium conveying apparatus 100.

FIG. 4A shows an example of the data structure of a pressure table.

FIG. 4B shows an example of the data structure of a correction table.

FIG. 5 schematically shows the configuration of storage device 140 and a processing circuit 150.

FIG. 6 is a flowchart showing an example of operation of a modification process.

FIG. 7 is a flowchart showing an example of operation of a medium reading process.

FIG. 8 is a flowchart showing an example of operation of an abnormality determination process,

FIG. 9 is a flowchart showing an example of operation of a multi-feed determination process.

FIG. 10 is a diagram for explaining characteristics of an ultrasonic signal.

FIG. 11 is a flowchart showing an example of operation of a conveyance abnormality. determination process.

FIG. 12A is a graph showing an example of a sound signal.

FIG. 12B is a graph showing an example of an absolute value signal of the sound signal.

FIG. 12C is a graph showing an example of a contour signal.

FIG. 12D is a graph showing an example of an estimated value.

FIG. 13A is a graph showing the relationship between atmospheric pressure and a sound pressure value.

FIG. 13B is a graph showing the relationship between atmospheric pressure and the value of an ultrasonic signal.

FIG. 14A is a graph showing the relationship between atmospheric pressure and the value of an ultrasonic signal.

FIG. 14B is a graph showing the relationship between atmospheric pressure and the value of an ultrasonic signal.

FIG. 14C is a graph showing the relationship between atmospheric pressure and the value of an ultrasonic signal.

FIG. 15 schematically shows the configuration of a processing circuit 250.

### DESCRIPTION OF EMBODIMENTS

Hereinafter, a medium conveying apparatus, a control method and a control program according to an embodiment, will be described with reference to the drawings. However, it should be noted that the technical scope of the invention is not limited to these embodiments, and extends to the inventions described in the claims and their equivalents.

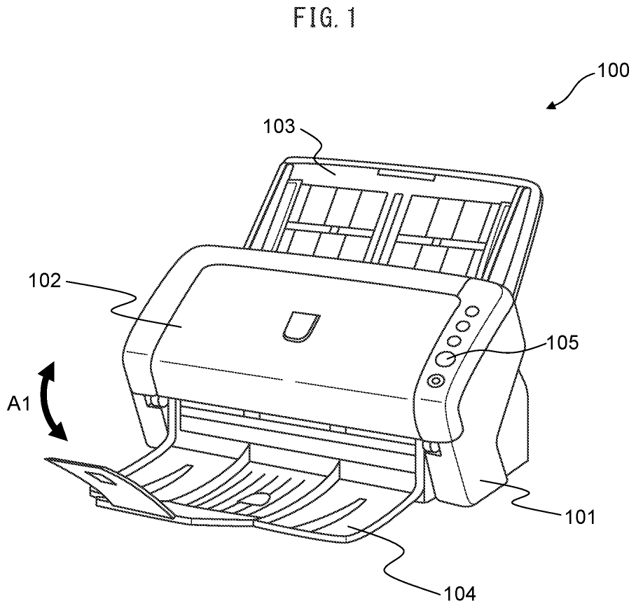

FIG. 1 is a perspective view showing a medium conveying apparatus 100 configured as an image scanner. The following describes an example in which the medium conveying apparatus 100 conveys a medium, such as a sheet of paper or a plastic card, as a source document; however, the medium conveying apparatus 100 may be any device that conveys a medium. For example, the medium conveying apparatus 100 may be a facsimile machine, an inkjet printer, a laser primer, or a multifunction peripheral (MET).

The medium conveying apparatus 100 includes a lower housing 101, an upper housing 102, a medium tray 103, an ejection tray 104, and operation buttons 105.

The upper housing 102 is located to cover the upper surface of the medium conveying apparatus 100, and engages with the lower housing 101 with hinges so as to be openable and closable at the time of a medium jam and cleaning of the inside of the medium conveying apparatus 100.

The medium tray 103 engages with the lower housing 101 so that a medium can be placed thereon. The ejection tray 104 engages with the lower housing 101 with hinges so as to be rotatable in the directions indicated by arrow Al, and can hold an ejected medium when opened as shown in FIG. 1.

The operation buttons 105 are located on the front surface of the upper housing 102, and, when pushed, generates and outputs an operation detection signal.

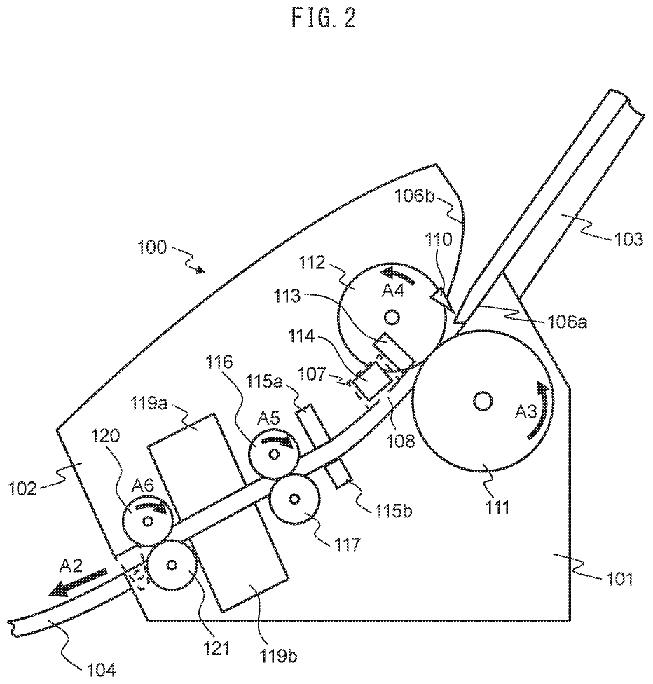

FIG. 2 is a diagram for explaining a conveyance path inside the medium conveying apparatus 100.

The medium conveying apparatus 100 includes a first medium sensor 110, a feed roller 111, a retard roller 112, a second medium sensor 113, a microphone 114, an ultrasonic transmitter 115a, an ultrasonic receiver 115b, a first conveyance roller 116, a first driven roller 117, a first imaging device 119a, a second imaging device 119b, a second conveyance roller 120, and a second driven roller 121, on a conveyance path inside the apparatus. The number of each roller is not limited to one, and may be two or more.

The upper surface of the lower housing 101 forms a lower guide 106a of the conveyance path of media whereas the lower surface of the upper housing 102 forms an upper guide 10Gb of the medium conveyance path. In FIG. 2, arrow A2 indicates a medium conveying direction. Hereafter, “upstream” and “downstream” refer to upstream and downstream as viewed in the medium conveying direction A2, respectively.

The first medium sensor 110 includes a contact sensor located upstream of the feed roller 111 and the retard roller 112, and detects whether a medium is placed on the medium tray 103. The first medium sensor 110 generates and outputs a first medium signal whose value varies between when a medium is placed on the medium tray 103 and when not.

The second medium sensor 113 is located downstream of the feed roller 111 and the retard roller 112 and upstream of the first conveyance roller 116 and the first driven roller 117, and detects whether there is a medium at its position. The second medium sensor 113 includes a light emitter and a light receiver provided on one side with respect to the medium conveyance path, and a reflecting member, such as a mirror, provided across the conveyance path from the light emitter and the light receiver. The light emitter emits light toward the conveyance path. The light receiver receives light emitted by the light emitter and reflected by the reflecting member, and generates and outputs a second medium signal, which is an electric signal corresponding to the intensity of the received light. Since a medium at the second medium sensor 113 blocks light emitted by the light emitter, the value of the second medium signal varies between when there is a medium at the second medium sensor 113 and when not. The light emitter and the light receiver may be provided opposite each other across the conveyance path; and the reflecting member may be omitted.

The microphone 114, which is an example of the sound receiver, is provided near the medium conveyance path, receives (collects) a sound (audible sound) generated during conveyance of a medium, and generates and outputs an analog sound signal corresponding to the received sound. The microphone 114 is located downstream of the feed roller 111 and the retard roller 112 and fixed to a frame 107 inside the upper housing 102. The upper guide 106b has a hole 108 at the position facing the microphone 114 so that the microphone 114 can collect a sound produced during conveyance of a medium more accurately, The microphone 114, whose sensitivity to sound collection can be set, collects a sound at the set sensitivity, and outputs a sound signal corresponding to the collected sound. The value of a sound signal generated by a sound having a certain sound pressure level is larger at a higher set sensitivity, and smaller at a lower set sensitivity.

The ultrasonic transmitter 115a and the ultrasonic receiver 115b are opposed across the medium conveyance path near the conveyance path. The ultrasonic transmitter 115a can output ultrasonic waves. The frequency of an audible sound is not less than 20 Hz nor greater than 20 kHz whereas that of ultrasonic waves is greater than 20 kHz and not greater than 300 MHz. The ultrasonic receiver 115b includes an analog signal generation circuit, an absolute value signal generation circuit, and an A/D converter. The analog signal generation circuit receives ultrasonic waves outputted from the ultrasonic transmitter 115a and having passed through a medium, generates an analog electric signal corresponding to the received ultrasonic waves, and outputs it to the absolute value signal generation circuit. The absolute value signal generation circuit generates an absolute value signal of the analog electric signal outputted from the analog signal generation circuit, and outputs it to the A/D converter. The A/D converter converts the analog absolute value signal outputted from the absolute value signal generation circuit to a digital ultrasonic signal, and outputs it. The absolute value signal generation circuit and/or the A/D converter may be provided outside the ultrasonic receiver 115b. The ultrasonic transmitter 115a and the ultrasonic receiver 115b will hereafter be referred to collectively as the ultrasonic sensor 115.

The first imaging device 119a includes an image sensor constructed from a contact image sensor (CIS) of a unit magnification optical system type including imaging elements based on a complementary metal oxide semiconductor (CMOS) and aligned in the main scanning direction. The first imaging device 119a also includes lenses that form images on the imaging elements, and an A/D converter that amplifies anal©g electric signals outputted from the imaging elements and that converts them to digital signals. The first imaging device 119a, images the back side of a medium to generate a read image, and outputs it.

Similarly, the second imaging device 119b includes an image sensor constructed from a CIS of a unit magnification optical system type including imaging elements based on a CMOS and aligned in the main scanning direction. The second imaging device 119b also includes lenses that form images on the imaging elements, and an A/D converter that amplifies analog electric signals outputted from the imaging elements and that converts them to digital signals. The second imaging device 119b images the front side of a medium to generate a read image, and outputs it.

The medium conveying apparatus 100 may include only the first imaging device 119a or the second imaging device 119b, and read only one side of a medium. Instead of the line sensor constructed from a CIS of a unit magnification optical system type including imaging elements based on a CMOS, a line sensor constructed from a CIS of a unit magnification optical system type including imaging elements based on charge-coupled devices (CCDs) may be used. Alternatively, a line sensor of a reduction optical system type including imaging elements based on a CMOS or CCDs may be used. The first imaging device 119a and the second imaging device 119b will hereafter be referred to collectively as the imaging device 119. A medium placed on the medium tray 103 is conveyed in the medium conveying direction A2 between the lower guide 106a and the upper guide 106b by the teed roller 111 rotating in the direction of arrow A3 in FIG. 2. The retard roller 112 rotates in the direction of arrow A4 in FIG. 2 during conveyance of a medium. When multiple media are placed on the medium tray 103, the action of the feed roller 111 and the retard roller 112 separates only a medium in contact with the feed roller 111 from the media placed on the medium tray 103. This restricts conveyance of the media except for the separated one (prevents a multi-feed). The feed roller 111 and the retard roller 112 function as a medium separator.

The medium is fed between the first conveyance roller 116 and the first driven roller 117 while being guided by the lower guide 106a and the upper guide 106b. The medium is fed between the first imaging device 119a and the second imaging device 119b by the first conveyance roller 116 rotating in the direction of arrow A5 in FIG. 2. The medium read by the imaging device 119 is ejected onto the ejection tray 104 by the second conveyance roller 120 rotating in the direction of arrow A6 in FIG. 2.

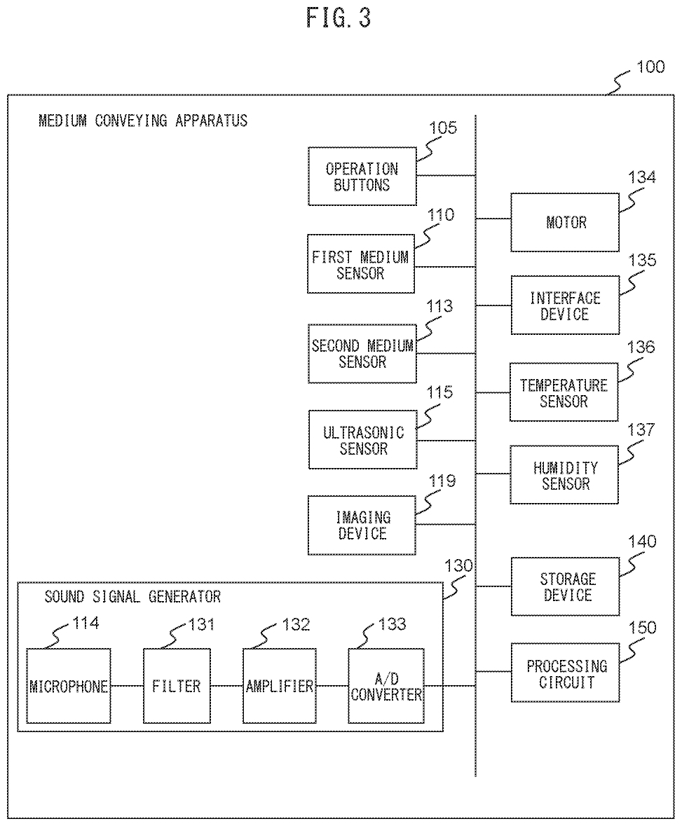

FIG. 3 is a block diagram schematically showing the configuration of the medium conveying apparatus 100.

In addition to the components described above, the medium conveying apparatus 100 further includes a sound signal generator 130, a motor 134, an interface device 135, a temperature sensor 136, a humidity sensor 137, storage device 140, and a processing circuit 150.

The sound signal generator 130, which is an example of the sound receiver, includes a filter 131, an amplifier 132, and an A/D converter 133 in addition to the microphone 114. The filter 131 applies a band-pass filter, which transmits a signal having a frequency in a predetermined band, to the analog sound signal outputted from the microphone 114, and outputs it to the amplifier 132. The amplifier 132 amplifies the signal outputted from the filter 131, and outputs it to the A/D converter 133. The amplifier 132, whose amplification factor can be set, amplifies the signal outputted from the filter 131 according to the set amplification factor. The value of a signal outputted from the amplifier 132 in response to input of a sound signal having a certain value is larger at a higher set amplification factor, and smaller at a lower set amplification factor. The A/D converter 133 samples the signal outputted from the amplifier 132 at predetermined intervals to generate a digital sound signal, and outputs it to the processing circuit 150. The filter 131, the amplifier 132, and/or the A/D converter 133 may be included in the microphone 114; and the microphone 114 may output a digital sound signal.

The motor 134 includes one or more motors, and rotates the feed roller 111, the retard roller 112, the first conveyance roller 116, and the second conveyance roller 120 according to control signals from the processing drcuit 150, thereby operating to convey a medium.

The interface device 135 includes an interface circuit, for example, conforming to a serial bus, such as a universal serial bus (USB). The interface device 135 is electrically connected to an information processing apparatus (not shown), such as a personal computer or a personal digital assistant, to transmit and receive a read image and various types of information. Instead of the interface device 135, a communication module may be used that includes an antenna transmitting and receiving wireless signals, and a wireless communication interface device for transmitting and receiving signals through a wireless communication channel in accordance with a predetermined communication protocol. The predetermined communication protocol is, for example, a wireless local area network (LAN).

The temperature sensor 136 detects the temperature at the medium conveying apparatus 100 (atmospheric temperature), and outputs temperature information indicating the detected temperature to the processing circuit 150.

The humidity sensor 137 detects the humidity at the medium conveying apparatus 100, and outputs humidity information indicating the detected humidity to the processing circuit 150,

The storage device 140 includes a memory device, such as a random access memory (RAM) or a read-only memory (ROM); a fixed disk device, such as a hard dish; or a portable storage device, such as a flexible disk or an optical disk. The storage device 140 contains computer programs, databases, and tables used for various processes of the medium conveying apparatus 100. The computer programs may be installed on the storage device 140 from a computer-readable, non-transitory portable storage medium by using a well-known set-up program, etc. The portable storage medium is, for example, a compact disc read-only memory (CD-ROM) or a digital versatile disc read-only memory (DVD -ROM).

The storage device 140 also contains a read image, a reference sensitivity of the microphone 114, a reference amplification factor of the amplifier 132, reference values of determination parameters, a pressure table, and a correction table. The determination parameters are used in a conveyance abnormality determination process for determining whether a medium conveyance abnormality has occurred. The determination parameters include a first threshold, a second threshold, an addition point, and a subtraction point. The first threshold is compared with the value of a sound signal. The second threshold is compared with an estimated value calculated based on the number of times the value of a sound signal is not less than the first threshold. The addition point is added to the estimated value when the value of a sound signal is not less than the first threshold. The subtraction point is subtracted from the estimated value when the value of a sound signal is less than the first threshold. The determination parameters may include another parameter. Details of the pressure table and the correction table will be described below.

The processing circuit 150 operates in accordance with a program prestored in the storage device 140. The processing circuit 150 is, for example, a central processing unit ((PU). A digital signal processor (DSP), a large-scale integration (LSI), an application specific integrated circuit (ASIC), or a field-programmable gate array (FPGA) may be used as the processing circuit 150.

The processing circuit 150 is connected to the operation buttons 105, the first medium sensor 110, the second medium sensor 113, the ultrasonic sensor 115, the imaging device 119, the sound signal generator 130, the motor 134, the interface device 135, the temperature sensor 136, the humidity sensor 137, and the storage device 140, and controls them. For example, the processing circuit 150 controls driving of the motor 134 and imaging by the imaging device 119 to acquire a read image. In addition, the processing circuit 150 determines whether a medium conveyance abnormality has occurred, based on a sound signal outputted from the sound signal generator 130. The processing circuit 150 detects atmospheric pressure, based on an ultrasonic signal outputted from the ultrasonic sensor 115. and modifies the sensitivity of the microphone 114, corrects a sound signal, or modifies a criterion for determination of a medium conveyance abnormality, based on the detected atmospheric pressure.

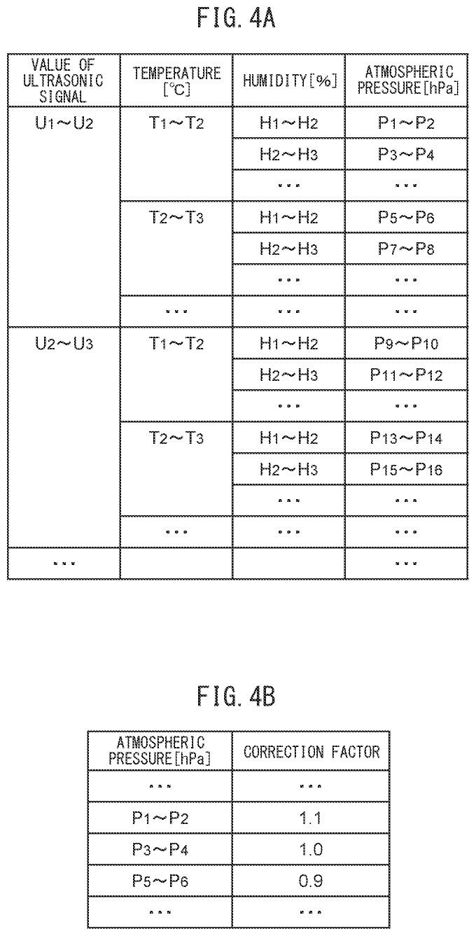

FIG. 4A shows an example of the data structure of the pressure table.

As shown in FIG. 4A, the pressure table contains the ranges of the value of an ultrasonic signal acquired when the ultrasonic transmitter 115a outputs ultrasonic waves and the ranges of the temperature, humidity, and atmospheric pressure at the medium conveying apparatus 100 in association with each other. The pressure table is set based on experimental results of measurement of the values of ultrasonic signals acquired when the ultrasonic transmitter 115a outputs ultrasonic waves with the medium conveying apparatus 100 placed under various environments (temperature, humidity, and atmospheric pressure). The pressure table may contain the ranges of the value of an ultrasonic signal, humidity, and atmospheric pressure at room temperature in association with each other. Alternatively, the pressure table may contain the ranges of the value of an ultrasonic signal, temperature, and atmospheric pressure at room humidity in association with each other. Alternatively, the pressure table may contain the ranges of the value of an ultrasonic signal and atmospheric pressure at room temperature and humidity in association with each other.

FIG. 4B shows an example of the data structure of the correction table.

As shown in FIG. 4B, the correction table contains the ranges of the atmospheric pressure at the medium conveying apparatus 100 and correction factors in association with each other. The correction factors are factors for correcting the sensitivity of the microphone 114, the value of a sound signal, or the determination parameters. As the correction factors are set factors to be multiplied by the sensitivity of the microphone 114, the amplification factor of the amplifier 132, the value of a sound signal outputted from the sound signal generator 130 as well as the first threshold, the second threshold, the addition point, or the subtraction point included in the determination parameters. As the correction factors may be set factors to be added to, subtracted from, or divided into the sensitivity, the amplification factor, the value of a sound signal, the first threshold, the second threshold, the addition point, or the subtraction point. The correction table may contain two or more sets of correction factors for correcting two or more parameters selected from among the sensitivity, the amplification factor, the value of a sound signal, the first threshold, the second threshold, the addition point, and the subtraction point.

The correction factors to be multiplied by or added to the sensitivity, the amplification factor, the value of a sound signal, or the addition point, or those to be divided into or subtracted from the first threshold, the second threshold, or the subtraction point are set to increase as the atmospheric pressure decreases. The correction factors to be multiplied by or added to the first threshold, the second threshold, or the subtraction point, or those to be divided into or subtracted from the sensitivity, the amplification factor, the value of a sound signal, or the addition point are set to decrease as the atmospheric pressure decreases. The correction factors for correcting the sensitivity, the amplification factor, or the value of a sound signal are set so that the levels of sound signals generated when a sound having a predetermined sound pressure level is produced with the medium conveying apparatus 100 placed under various atmospheric pressures may be the same. The correction factors for correcting the first threshold, the second threshold, the addition point, or the subtraction point are set so that the results of determination of a medium conveyance abnormality made when a sound having a predetermined sound pressure level is produced with the medium conveying apparatus 100 placed under various atmospheric pressures may match.

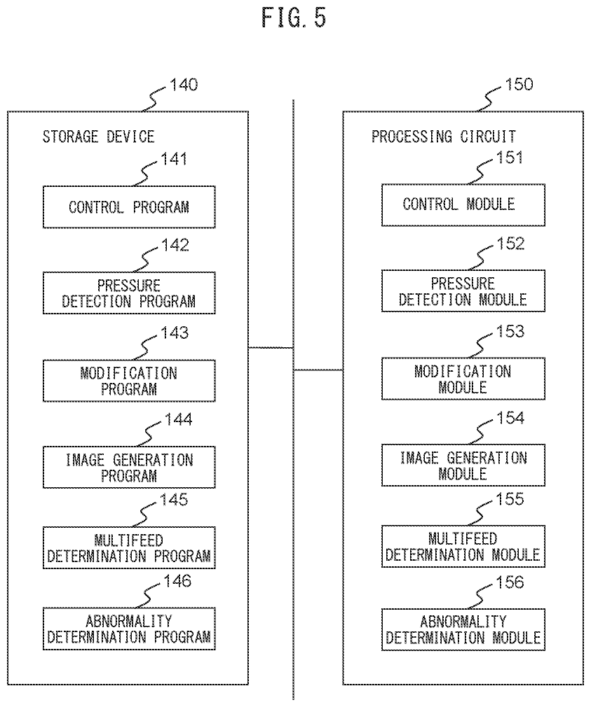

FIG. 5 schematically shows the configuration of the storage device 140 and the processing circuit 150.

As shown in FIG. 5, the storage device 140 contains programs such as a control program 141, a pressure detection program 142, a modification program 143, an image generation program 144, a multi-feed determination program 145, and an abnormality determination program 146. These programs are functional modules implemented by software executed by a processor. The processing circuit 150 reads the programs stored in the storage device 140 and operates in accordance with the read programs, functioning as a control module 151, a pressure detection module 152, a modification module 153, an image generation module 154, a multi-feed determination module 155, and an abnormality determination module 156.

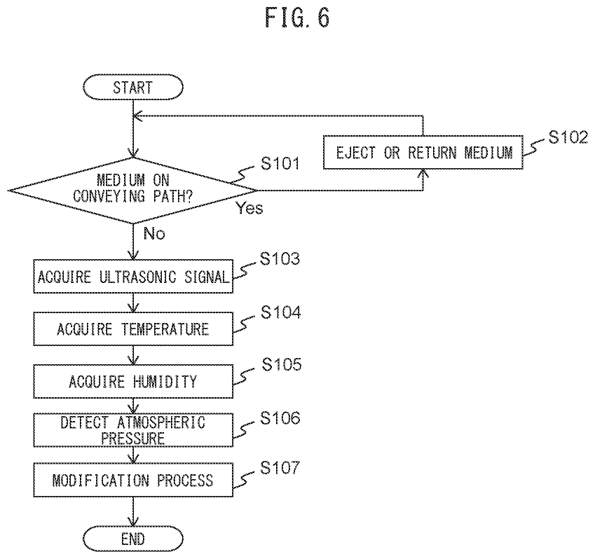

FIG. 6 is a flowchart showing an example of operation of a modification process by the medium conveying apparatus 100.

With reference to the flowchart shown in FIG. 6, an example of operation of a modification process by the medium conveying apparatus 100 will be described below. The operation flow described below is executed mainly by the processing circuit 150 in accordance with a program prestored in the storage device 140 in cooperation with the components of the medium conveying apparatus 100. The operation flow shown in FIG. 6 is executed, for example, at the initialization time after power-on of the medium conveying apparatus 100 (at the startup of the apparatus). The operation flow shown in FIG. 6 may be executed regularly.

First, the control module 151 determines whether there is a medium on the medium conveyance path, based on a second medium signal received from the second medium sensor 113 (step S101).

When there is a medium on the medium conveyance path, the control module 151 drives the motor 134 to rotate the feed roller 111, the retard roller 112, the first conveyance roller 116, and the second conveyance roller 120, causing the medium to be ejected to the ejection tray 104 or returned to the medium tray 103 (step S102). The control module 151 then returns the process to step S101.

When there is no medium on the medium conveyance path, the pressure detection module 152 makes the ultrasonic transmitter 115a output ultrasonic waves, and acquires an ultrasonic signal from the ultrasonic sensor 115 (step S103).

The modification module 153 then acquires temperature information from the temperature sensor 136 (step S104).

The modification module 153 then acquires humidity information from the humidity sensor 137 (step S105).

The pressure detection module 152 then detects the atmospheric pressure at the location of the medium conveying apparatus 100, based on the ultrasonic signal, the temperature indicated by the temperature information, and the humidity indicated by the humidity information (step S106). The pressure detection module 152 determines the atmospheric pressure corresponding to the value of the ultrasonic signal, the temperature indicated by the temperature information, and the humidity indicated by the humidity information from the pressure table, and detects the determined atmospheric pressure as the atmospheric pressure at the location of the medium conveying apparatus 100.

Based on the atmospheric pressure detected by the pressure detection module 152, the modification module 153 then executes one or more of the following: modification of the sensitivity of the microphone 114, correction of a sound signal generated by the sound signal generator 130, and modification of a criterion for determination of a medium conveyance abnormality by the abnormality determination module 156 (step S107).

From the correction table, the modification module 153 determines the correction factor corresponding to the atmospheric pressure detected by the pressure detection module 152. The modification module 153 sets the reference sensitivity of the microphone 114 multiplied by the determined correction factor as the sensitivity of the microphone 114. Alternatively, the modification module 153 sets the reference amplification factor of the amplifier 132 multiplied by the determined correction factor as the amplification factor of the amplifier 132. Alternatively, the modification module 153 sets the determined correction factor in the storage device 140 as the correction factor for correcting the value of a sound signal outputted by the sound signal generator 130. Alternatively, the modification module 153 sets the reference value of the first threshold multiplied by the determined correction factor in the storage device 140 as the first threshold. Alternatively, the modificad on module 153 sets the reference value of the second threshold multiplied by the determined correction factor in the storage device 140 as the second threshold. Alternatively, the modification module 153 sets the reference value of the addition point or the subtraction point multiplied by the determined correction factor in the storage device 140 as the addition point or the subtraction point.

The modification module 153 may set each parameter by performing addition, subtraction, or division of the determined correction factor on the reference sensitivity, the reference amplification factor, or the reference value of the first threshold, the second threshold, the addition point, or the subtraction point.

The modification process is then terminated. The processing of steps S104 and S105 may be omitted, and in step S106, the pressure detection module 152 may detect the atmospheric pressure in the pressure table corresponding to the value of the ultrasonic signal as the atmospheric pressure at the location of the medium conveying apparatus 100. Alternatively, the processing of step S104 may be omitted, and in step S106, the pressure detection module 152 may detect the atmospheric pressure in the pressure table corresponding to the value of the ultrasonic signal and the humidity indicated by the humidity information as the atmospheric pressure at the location of the medium conveying apparatus 100. Alternatively, the processing of step S105 may be omitted, and in step S106, the pressure detection module 152 may detect the atmospheric pressure in the pressure table corresponding to the value of the ultrasonic signal and the temperature indicated by the temperature information as the atmospheric pressure at the location of the medium conveying apparatus 100.

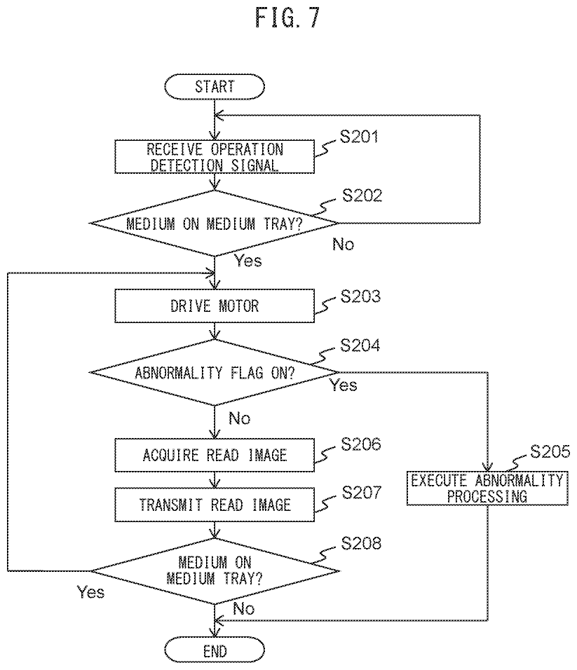

FIG. 7 is a flowchart showing an example of operation of a medium reading process by the medium conveying apparatus 100.

With reference to the flowchart shown in FIG. 7, an example of operation of a medium reading process by the medium conveying apparatus 100 will be described below. The operation flow described below is executed mainly by the processing circuit 150 in accordance with a program prestored in the storage device 140 in cooperation with the components of the medium conveying apparatus 100. The operationfl.)w shown in FIG. 7 is executed regularly.

First, the control module 151 stands by until it receives an operation detection signal of an instruction to read a medium from an operation button 105 for the reading instruction pushed by a user (step S201).

The control module 151 then determines whether a medium is placed on the medium tray 103, based on a first medium signal received from the first medium sensor 110 (step S202).

When no medium is placed on the medium tray 103, the control module 151 returns the process to step S201 and stands by until an operation detection signal is newly received from the operation button 105. The control module 151 may request a user to place a medium, for example, with a display, a speaker, or a light-emitting diode (LED) (not shown).

When a medium is placed on the medium tray 103, the control module 151 drives the motor 134 to rotate the feed roller 111, the retard roller 112, the first conveyance roller 116, and the second conveyance roller 120, causing the medium to be conveyed (step S203).

The control module 151 then determines whether an abnormality flag is ON (step S204). The abnormality flag is set OFF at the start of the medium reading process, and set ON if in an abnormality determination process described below it is determined that an abnormality has occurred.

When the abnormality flag is ON, the control module 151 stops the motor 134 to stop conveyance of the medium as abnormality process. In addition, the control module 151 notifies a user of the occurrence of an abnormality, for example, with a speaker or an LED (not shown), sets the abnormality flag OFF (step S205), and then terminates the sequence of steps.

When the abnormality flag is not ON, the image generation module 154 makes the imaging device 119 read the conveyed medium, and acquires a read image from the imaging device 119 (step S206).

The image generation module 154 then transmits the read image to an information processing apparatus (not shown) via the interface device 135 (step S207). if it is not connected to an information processing apparatus, the image generation module 154 stores the read image in the storage device 140.

The control module 151 then determines whether a medium remains on the medium tray 103. based on a first medium signal received from the first medium sensor 110 (step S208).

When a medium remains on the medium tray 103, the control module 151 returns the process to step S203, and repeats the processing of steps 5203 to 5208. When no medium remains on the medium tray 103, the control module 151 terminates the sequence of steps.

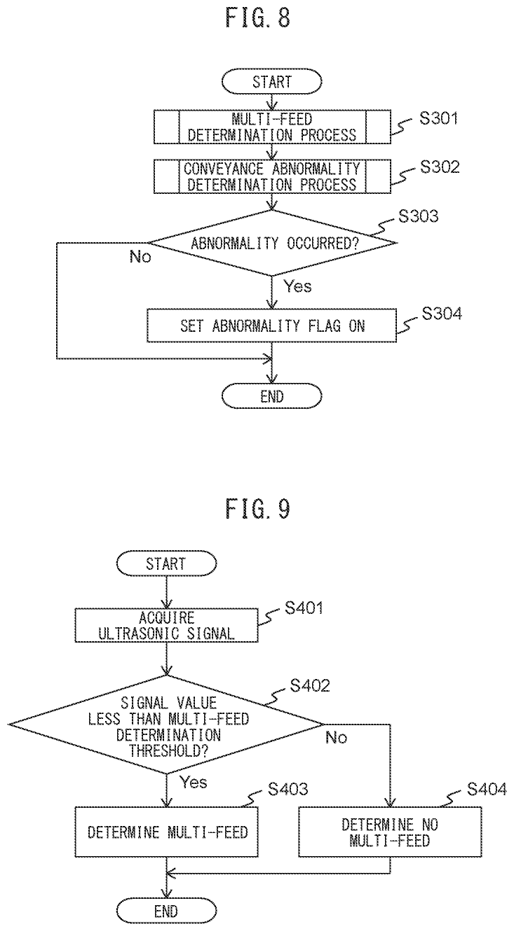

FIG. 8 is a flowchart showing an example of operation of an abnormality determination process.

The operation flow described below is executed mainly by the processing circuit 150 in accordance with a program prestored in the storage device 140 in cooperation with the components of the medium conveying apparatus 100. The flow shown in FIG. 8 is executed at predetermined intervals during conveyance of a medium. Before the abnormality determination process is executed, the control module 151 makes the ultrasonic transmitter 115a output ultrasonic waves.

First, the multi-feed determination module 155 executes a multi-feed determination process (step S301). In the multi-feed determination process, the multi-feed determination module 155 determines whether a multi-feed of a medium has occurred, based on the value of an ultrasonic signal acquired from the ultrasonic sensor 115 and a multi-feed threshold set in the storage device 140, Details of the multi-feed determination process will be described below

The abnormality determination module 156 then executes a conveyance abnormality determination process (step 8302). In the conveyance abnormality determination process, the abnormality determination module 156 determines whether a conveyance abnormality, such as a jam or skew of a medium, has occurred, based on a sound signal acquired from the sound signal generator 130. Details of the conveyance abnormality determination process will be described below

The control module 151 then determines whether an abnormality has occurred in a medium conveyance process (step 8303). If at least a multi-feed or a conveyance abnormality of a medium has occurred, the control module 151 determines that an abnormality has occurred. In other words, only if neither multi-feed nor conveyance abnormality of a medium has occurred, the control module 151 determines that no conveyance abnormality has occurred.

If an abnormality has occurred in a medium conveyance process, the control module 151 sets the abnormality flag ON (step S304), and terminates the sequence of steps. If no conveyance abnormality has occurred in a medium conveyance process, the control module 151 terminates the sequence of steps without any particular processing.

FIG. 9 is a flowchart showing an example of operation of the multi-feed determination process.

The operation flow shown in FIG. 9 is executed in step S301 of the flowchart shown in FIG. 8.

First, the multi-feed determination module 155 acquires an ultrasonic signal from the ultrasonic sensor 115 (step S401).

The multi-feed determination module 155 then determines whether the value of the acquired ultrasonic signal is less than the multi-feed threshold (step S402).

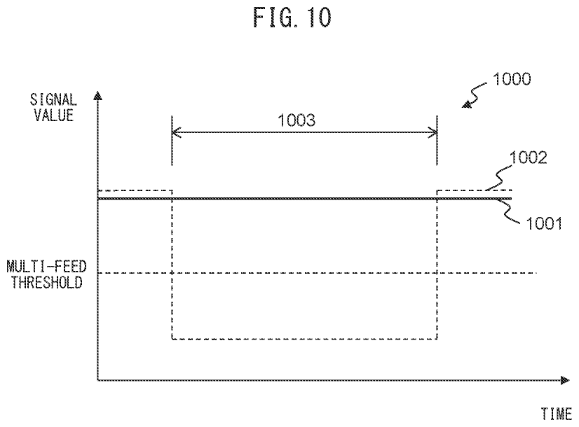

FIG. 10 is a diagram for explaining characteristics of an ultrasonic signal.

In the graph 1000 of FIG. 10, the solid line 1001 shows the characteristics of an ultrasonic signal for the case of conveyance of a single sheet of paper whereas the broken line 1002 shows those for the case of a multi-feed of sheets. The abscissa and the ordinate of the graph 1000 represent time and the value of the ultrasonic signal, respectively. The multi-feed causes the value of the ultrasonic signal of the broken line 1002 to fall in a section 1003. Thus, the multi-feed determination module 155 can determine whether a multi-feed of a medium has occurred, based on whether the value of the ultrasonic signal is less than the multi-feed threshold.

When the value of the ultrasonic signal is less than the multi-feed threshold, the multi-feed determination module 155 determines that a multi-feed of a medium has occurred (step S403), and terminates the sequence of steps. When the value of the ultrasonic signal is not less than the multi-feed threshold, the multi-feed determination module 155 determines that no multi-feed of a medium has occurred (step S404), and terminates the sequence of steps. In this way, the multi-feed determination module 155 determines whether a multi-feed of a medium has occurred, based on the value of the ultrasonic signal and the multi-feed threshold,

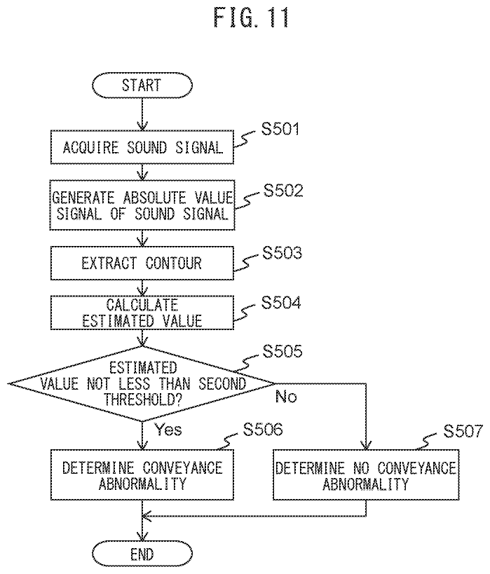

FIG. 11 is a flowchart showing an example of operation of the conveyance abnormality determination process.

The operation flow shown in FIG. 11 is executed in step S302 of the flowchart shown in FIG. 8.

First, the abnormality determination module 156 acquires a sound signal from the sound signal generator 130 (step S501).

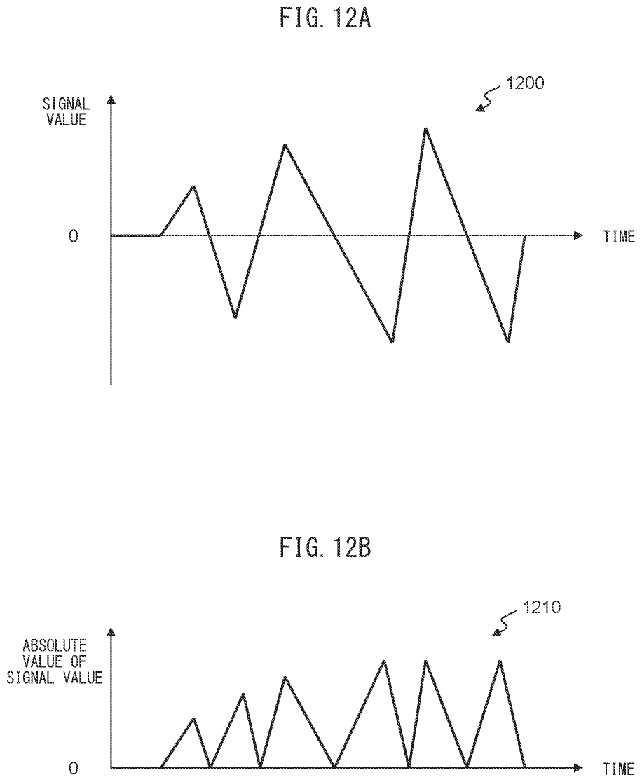

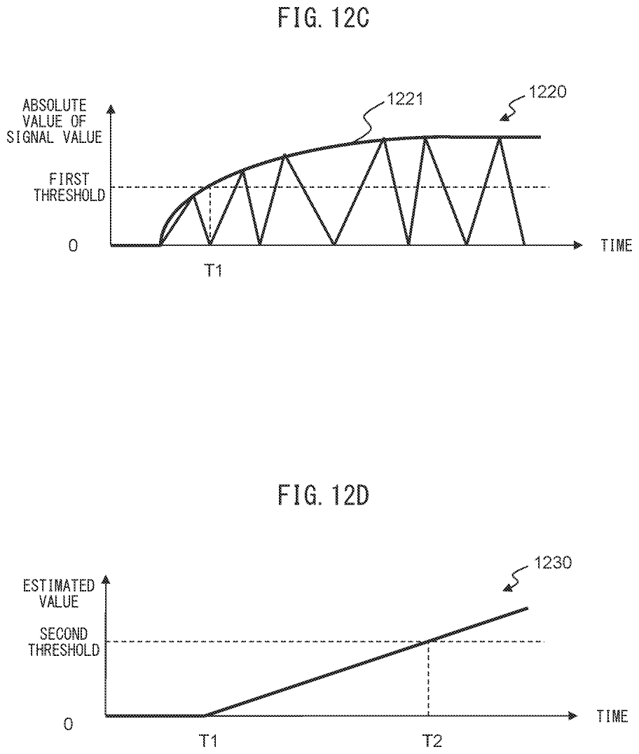

FIG. 12A is a graph showing an example of the sound signal. The graph 1200 in FIG. 12A shows a sound signal outputted from the sound signal generator 130. The abscissa and the ordinate of the graph 1200 represent time and the signal value, respectively.

When correcting a sound signal outputted by the sound signal generator 130 with a correction factor, the modification module 153 reads the currently set correction factor from the storage device 140 and multiplies the value of the sound signal acquired from the sound signal generator 130 by the correction factor to correct the sound signal. The modification module 153 may correct the sound signal acquired from the sound signal generator 130 by performing addition, subtraction, or division of the correction factor on the value of the sound signal. In this way, the modification module 153 corrects the sound signal outputted by the sound signal generator 130, based on the atmospheric pressure detected by the pressure detection module 152.

The abnormality determination module 156 then generates an absolute value signal of the sound signal outputted from the sound signal generator 130 (step S502),

FIG. 12B is a graph showing an example of the absolute value signal of the sound signal. The graph 1210 in FIG. 12B shows an absolute value signal of the sound signal of the graph 1200. The abscissa and the ordinate of the graph 1210 represent time and the absolute value of the signal value, respectively.

The abnormality determination module 156 then extracts the contour of the absolute value signal of the sound signal to generate a contour signal (step S503). As the contour signal, the abnormality determination module 156 extracts an envelope.

FIG. 12C is a graph showing an example of the contour signal. The graph 1220 in FIG. 12C shows an envelope 1221 of the absolute value signal of the sound signal of the graph 1210. The abscissa and the ordinate of the graph 1220 represent time and the absolute value of the signal value, respectively.

The abnormality determination module 156 then calculates an estimated value, based on the contour signal (step S504). The abnormality determination module 156 calculates the estimated value so that it increases when the value of the contour signal is not less than the first threshold and that it decreases when the signal value is less than the first threshold. The abnormality determination module 156 determines whether the value of the envelope 1221 is not less than the first threshold, at predetermined intervals (e.g., at sampling intervals of analog-to-digital conversion). When the value of the envelope 1221 is not less than the first threshold, the abnormality determination module 156 adds the addition point to the estimated value; when it is less than the first threshold, it subtracts the subtraction point from the estimated value. The first threshold, the addition point, and/or the subtraction point are set in the modification process. If the first threshold, the addition point, or the subtraction point is not set in the modification process, the reference value of the first threshold, the addition point, or the subtraction point is used as the first threshold, the addition point, or the subtraction point.

FIG. 12D is a graph showing an example of the estimated value. The graph 1230 in FIG. 121 shows an estimated value calculated for the envelope 1221 of the graph 1220. The abscissa and the ordinate of the graph 1230 represent, time and a counter value, respectively.

The abnormality determination module 156 then determines whether the estimated value is not less than the second threshold (step S505). The second threshold is set in the modification process. If the second threshold is not set in the modification process, the reference value of the second threshold is used as the second threshold. When the estimated value is not less than the second threshold, the abnormality determination module 156 determines that a medium conveyance abnormality, such as a jam of a medium or skew (rotation) of stapled media around a staple, has occurred (step S506), and terminates the sequence of steps. When the estimated value is less than the second threshold, the abnormality determination module 156 determines that no medium conveyance abnormality has occurred (step S507), and terminates the sequence of steps.

In FIG. 12C, the envelope 1221 exceeds the first threshold at time T1, and is thereafter kept greater than the first threshold. Thus, the estimated value increases from time Ti and exceeds the second threshold at time T2, as shown in FIG. 12D; and the abnormality determination module 156 then determines that a medium conveyance abnormality has occurred.

In this way, the abnormality determination module 156 determines whether a medium conveyance abnormality has occurred, based on a sound signal. In particular, the abnormality determination module 156 adds the addition point or subtracts the subtraction point, based on a comparison between a sound signal and the first threshold, to calculate an estimated value, and determines whether a medium conveyance abnormality has occurred, based on a comparison between the estimated value and the second threshold.

In step S503, the abnormality determination module 156 may acquire a signal by executing peak hold on the absolute value signal of the sound signal at predetermined intervals as the contour signal, instead of an envelope. Alternatively, the abnormality determination module 156 may acquire a signal by applying a known smoothing filter, averaging filter, or low-pass filter to the absolute value signal of the sound signal as the contour signal.

The following describes technical significance of modification of the sensitivity of the microphone 114, correction of a sound signal, or setting of a criterion for determination of a medium conveyance abnormality by the abnormality determination module 156 based on an ultrasonic signal.

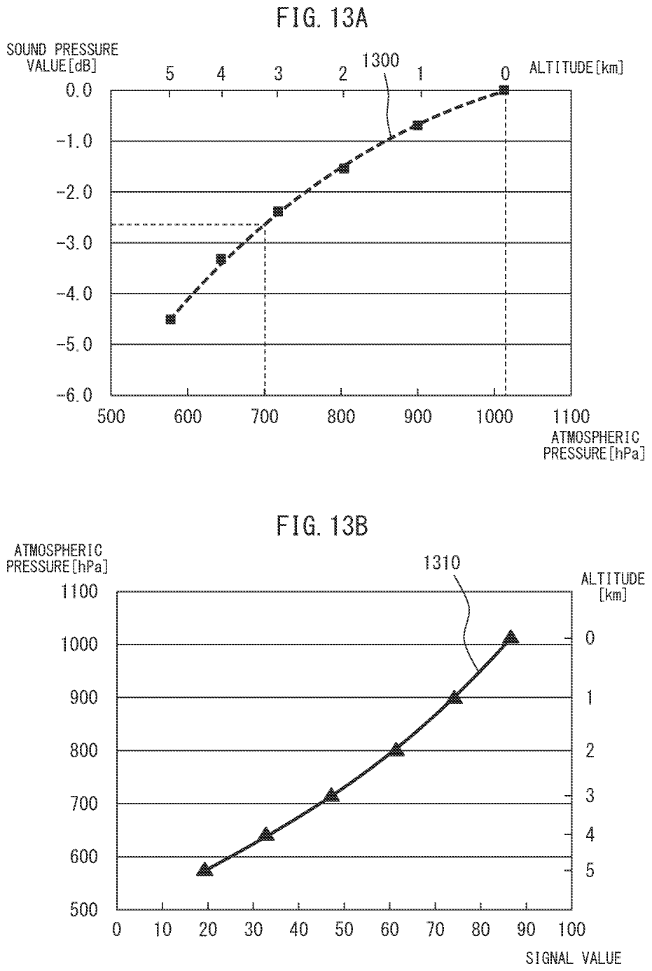

FIG. 13A is a graph 1300 showing the relationship between the atmospheric pressure at the location of the medium conveying apparatus 100 and the sound pressure value of a sound collected by the microphone 114 when a predetermined sound is produced in the medium conveyance path of the medium conveying apparatus 100.

In FIG. 13A, the abscissa represents the atmospheric pressure [hPa] (lower scales) and the altitude [km] (upper scales) at the location of the medium conveying apparatus 100 whereas the ordinate represents the sound pressure value [dB]. The graph 1300 shows actual measurements acquired by experiment. As shown in FIG. 13A, the atmospheric pressure at the medium conveying apparatus 100 decreases, the sound attenuates, and the sound pressure value decreases, as the altitude of the location of the medium conveying apparatus 100 increases.

For example, even when a sound of the same level is produced, the sound pressure value of a sound collected by the microphone 114 under an atmospheric pressure of 700 [hPa] is 2.6 [dB] lower than that of a sound collected by the microphone 114 under an atmospheric pressure of 1010 [hPa]. In other words, setting of a criterion for determination that a conveyance abnormality has occurred when a predetermined sound is produced under an atmospheric pressure of 1010 [hPa] may lead to erroneous detertnination that no medium conveyance abnormality has occurred when the predetermined sound is produced under an atmospheric pressure of 700 [hPa]. In addition, setting of a criterion for determination that no conveyance abnormality has occurred when a predetermined sound is produced under an atmospheric pressure of 700 [hPa] may lead to erroneous determination that a medium conveyance abnormality has occurred when the predetermined sound is produced under an atmospheric pressure of 1010 [hPa].

The medium conveying apparatus 100 modifies the sensitivity of the microphone 114, corrects a sound signal, or modifies a criterion for determination of a medium conveyance abnormality by the abnormality determination module 156 so as to be more likely to determine that a medium conveyance abnormality has occurred as the atmospheric pressure at the medium conveying apparatus 100 is lower. This enables the medium conveying apparatus 100 to correctly determine whether a medium conveyance abnormality has occurred, from a sound, regardless of the altitude of its location. In particular, the medium conveying apparatus 100 can correctly determine whether a medium conveyance abnormality has occurred, from a sound, when placed at an altitude of 0 to 5 km.

FIG. 13B is a graph 1310 showing the relationship between the atmospheric pressure at the location of the medium conveying apparatus 100 and the value of an ultrasonic signal outputted by the ultrasonic sensor 115.

In FIG. 13B, the abscissa represents the value of the ultrasonic signal whereas the ordinate represents the atmospheric pressure [hPa] (left scales) and the altitude [km] (right scales) at the location of the medium conveying apparatus 100. The graph 1310 shows the atmospheric pressure at the location of the medium conveying apparatus 100 (or the altitude of the location) and the value of the ultrasonic signal for the case that there is no medium on the medium conveyance path. As shown in FIG. 13B, the atmospheric pressure at the medium conveying apparatus 100 decreases, the ultrasonic waves attenuate, and the value of the ultrasonic signal decreases, as the altitude of the location of the medium conveying apparatus 100 increases. Thus, the medium conveying apparatus 100 can estimate the atmospheric pressure at its location from the value of the ultrasonic signal.

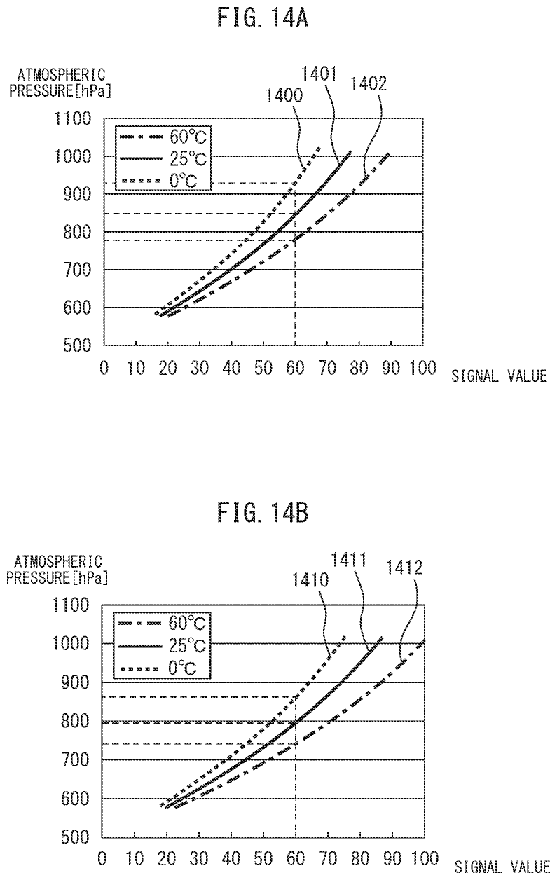

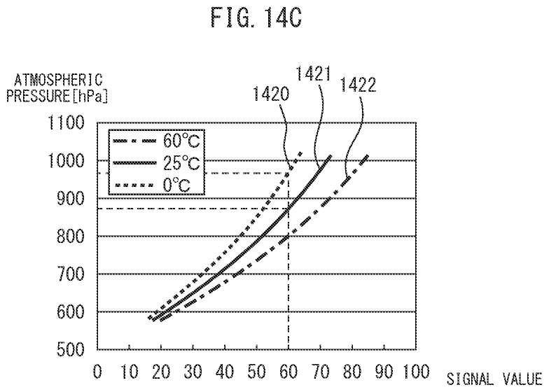

FIGS. 14A, 1413, and 14C are graphs showing the relationship between the atmospheric pressure and the value of an ultrasonic signal regarding different temperatures and humidities at the location of the medium conveying apparatus 100.

The abscissas and the ordinates of FIGS. 14A to 14C represent the value of an ultrasonic signal and the atmospheric pressure [hPa] at the location of the medium conveying apparatus 100, respectively. Graphs 1400 to 1402 in FIG. 14A show the relationship between the atmospheric pressure and the value of an ultrasonic signal at a relative humidity (RH) of 30%. Graphs 1410 to 1412 in FIG. 14B show the relationship between the atmospheric pressure and the value of an ultrasonic signal at a humidity RH of 50%. Graphs 1420 to 1422 in FIG. 14C show the relationship between the atmospheric pressure and the value of an ultrasonic signal at a humidity RH of 80%. The graphs 1400, 1410, and 1420 show the relationship between the atmospheric pressure and the value of an ultrasonic signal at a temperature of 0 degree C. The graphs 1401, 1411, and 1421 show the relationship between the atmospheric pressure and the value of an ultrasonic signal at a temperature of 25 degree C. The graphs 1402, 1412, and 1422 show the relationship between the atmospheric pressure and the value of an ultrasonic signal at a temperature of 60 degree C.

The graphs 1400 to 1402. 1410 to 1412, and 1420 to 1422 show the atmospheric pressure at the location of the medium conveying apparatus 100 and the value of an ultrasonic signal for the case that there is no medium on the medium conveyance path.

As shown in FIGS. 14A to 14C, the atmospheric pressure slightly differs corresponding to temperature and humidity even if the value of the ultrasonic signal is the same. For example, in the case that the value of the ultrasonic signal is 60, when the humidity RH is 30%, the atmospheric pressures at temperatures of 60, 25, and 0 degrees C. are 780, 850, and 940 [hPa], respectively. When the humidity RH is 50%, the atmospheric pressures at temperatures of 60, 25, and 0 degrees C. are 740, 800, and 860 [hPa], respectively. When the humidity RH is 80%, the atmospheric pressures at temperatures of 60, 25, and 0 degrees C. are 800, 870, and 960 [hPa], respectively.

Thus, under the same atmospheric pressure, the ultrasonic waves attenuate and the value of the ultrasonic signal decreases, as the temperature at the medium conveying apparatus 100 decreases. Therefore the use of the temperature at the medium conveying apparatus 100 enables the pressure detection module 152 to detect the atmospheric pressure at the medium conveying apparatus 100 more accurately, based on an ultrasonic signal.

In addition, the value of an ultrasonic signal varies corresponding to the humidity at the medium conveying apparatus 100. The use of the humidity at the medium conveying apparatus 100 enables more accurate detection of the atmospheric pressure at the medium conveying apparatus 100 based on an ultrasonic signal.

The value of a sound signal also varies corresponding to the temperature or humidity at the medium conveying apparatus 100; however, the variation in the value of a sound signal is little and can be disregarded. Thus, the modification module 153 does not modify the sensitivity of the microphone 114, correct a sound signal, nor modify a criterion for determination of a medium conveyance abnormality, based on temperature or humidity.

However, the modification module 153 may modify the sensitivity of the microphone 114, correct a sound signal, or modify a criterion for determination of a medium conveyance abnormality, based on temperature andlor humidity, In this case, the medium conveying apparatus 100 stores the range of the atmospheric pressure at its location, that of the temperature and/or humidity, and the correction factors in the correction table in association with each other. The correction factors are set so that the levels of sound signals generated when a sound having a predetermined sound pressure level is produced with the medium conveying apparatus 100 placed under various environments (atmospheric pressure, temperature, and/or humidity) may be the same or that the results of determination of a medium conveyance abnormality made in these conditions may match. In step S107 of FIG. 6, the modification module 153 determines the correction factor corresponding to the atmospheric pressure detected by the pressure detection module 152 and to the temperature indicated by the temperature information acquired from the temperature sensor 136 and/or the humidity indicated by the humidity information acquired from the humidity sensor 137, from the correction table.

As described above in detail, the medium conveying apparatus 100 detects atmospheric pressure, based on an ultrasonic signal, and corrects a parameter for sound-based determination of a medium conveyance abnormality, based on the detected atmospheric pressure. This enables the medium conveying apparatus 100 to more accurately determine whether a medium conveyance abnormality has occurred.

The medium conveying apparatus 100 uses the ultrasonic sensor 115, which is used for determining whether a multi-feed of a medium has occurred, to detect the atmospheric pressure at its location. The medium conveying apparatus 100 does not need a special sensor for detecting the atmospheric pressure at its location, and thus, can detect the atmospheric pressure while avoiding increases in the apparatus size and cost. In addition, users need not disable the function of detecting a medium conveyance abnormality nor modify a parameter therefor to prevent erroneous detection of a conveyance abnormality when the medium conveying apparatus 100 is used at particularly high altitude, which enables improvement in users' convenience.

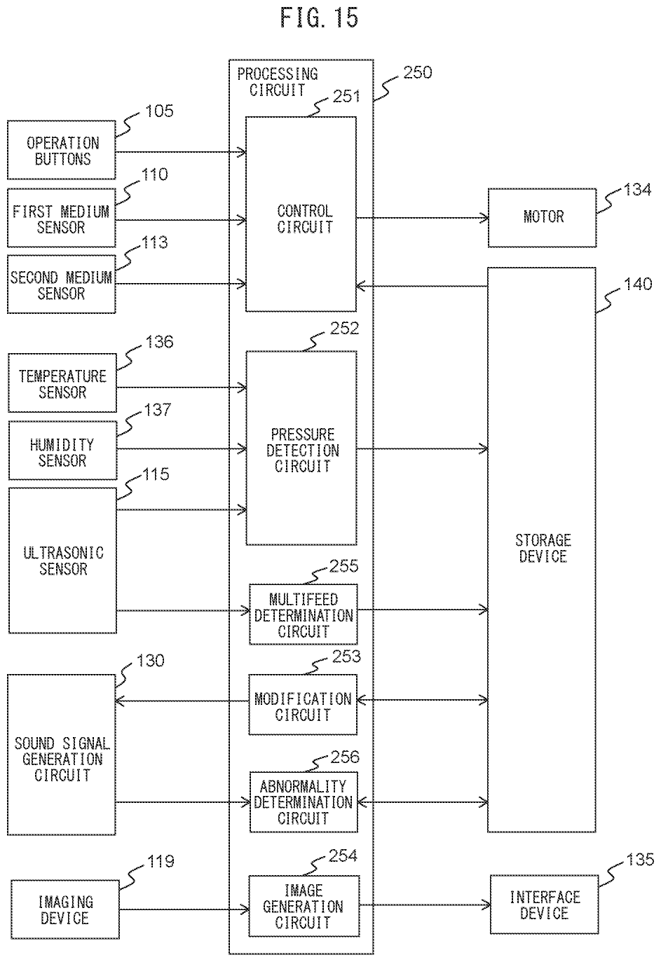

FIG. 15 schematically shows the configuration of a processing circuit 250 of a medium conveying apparatus according to another embodiment. The processing circuit 250 includes a control circuit 251, a pressure detection circuit 252, a modification circuit 253, an image generation circuit 254, a multi-feed determination circuit 255, and an abnormality determination circuit 256. These circuits may be configured by separate integrated circuits, microprocessors, or firmware.

The control circuit 251, which is an example of a control module, has a function similar to that of the control module 151. The control circuit 251 receives an operation detection signal, a first medium signal, and a second medium signal from the operation buttons 105, the first medium sensor 110, and the second medium sensor 113, respectively, and reads the abnormality flag from the storage device 140. The control circuit 251 drives the motor 134, based on the received or read information, to convey a medium.

The pressure detection circuit 252, which is the example of the pressure detection module, has a function similar to that of the pressure detection module 152. The pressure detection circuit 252 receives an ultrasonic signal, temperature information, and humidity information from the ultrasonic sensor 115, the temperature sensor 136, and the humidity sensor 137, respectively, detects atmospheric pressure, based on the received information, and stores it in the storage device 140.

The modification circuit 253, which is an example of the modification module, has a function similar to that of the modification module 153. The modification circuit 253 reads atmospheric pressure from the storage device 140, and modifies the sensitivity of the microphone 114 or the amplification factor of the amplifier 132 of the sound signal generator 130, based on the read atmospheric pressure. Alternatively, the modification circuit 253 reads a sound signal outputted by the sound signal generator 130 or a determination parameter from the storage device 140, corrects the sound signal or the determination parameter, based on the atmosphetic pressure, and stores it in the storage device 140.

The image generation circuit 254, which is an example of an image generation module, has a function similar to that of the image generation module 154. The image generation circuit 254 receives a read image from the imaging device 119, and transmits it to an information processing apparatus (not shown) via the interface device 135.

The multi-feed determination circuit 255, which is an example of a multi-feed determination module, has a function similar to that of the multi-feed determination module 155. The multi-feed determination circuit 255 receives an ultrasonic signal from the ultrasonic sensor 115, determines whether a multi-feed of a medium has occurred, based on the received ultrasonic signal, and updates the abnormality flag stored in the storage device 140 according to the result of determination.

The abnormality determination circuit 256, which is an example of the abnormality determination module, has a function similar to that of the abnormality determination module 156. The abnormality determination circuit 256 receives a sound signal from the sound signal generator 130, and stores it in the storage device 140. In addition, the abnormality determination circuit 256 reads a determination parameter from the storage device 140, determines whether a medium conveyance abnormality has occurred, based on the sound signal and the determination parameter, and updates the abnormality flag stored in the storage device 140 according to the result of determination.

As described above in detail, the medium conveying apparatus including the processing circuit 250 can also determine whether a medium conveyance abnormality has occurred more accurately.

### REFERENCE SIGNS LIST

100 medium conveying apparatus

114 microphone

115a ultrasonic transmitter

115b ultrasonic receiver

130 sound signal generator

136 temperature sensor

137 humidity sensor

152 pressure detection module

153 modification module

155 multi-feed determination module

156 abnormality determination module

1. A medium conveying apparatus comprising:
an ultrasonic transmitter capable of outputting an ultrasonic wave;
an ultrasonic receiver opposed to the ultrasonic transmitter, to receive the ultrasonic wave and output an ultrasonic signal corresponding to the received ultrasonic wave;
a sound receiver to receive a sound and generate a sound signal corresponding to the received sound; and
a processor to
detect atmospheric pressure, based on the ultrasonic signal,
determine whether a medium conveyance abnormality has occurred, based on the sound signal and
modify sensitivity of the sound receiver, correct the sound signal, or modify a criterion for determination of a medium conveyance abnormality, based on the atmospheric pressure.

2. The medium conveying apparatus according to claim 1, further comprising a temperature sensor to detect temperature, wherein
the processor detects the atmospheric pressure, further based on the temperature.

3. The medium conveying apparatus according to claim 1, further comprising a humidity sensor to detect humidity, wherein
the processor detects the atmospheric pressure, further based on the humidity.

4. The medium conveying apparatus according to claim 1, wherein the processor determinc determines whether a multi-feed of a medium has occurred, based on the ultrasonic signal.

5. A method for determining whether a medium conveyance abnormality has occurred, the method comprising:
outputting an ultrasonic wave by an ultrasonic transmitter;
receiving the ultrasonic wave and outputting an ultrasonic signal corresponding to the received ultrasonic wave, by an ultrasonic receiver opposed to the ultrasonic transmitter;
receiving a sound and generating a sound signal corresponding to the received sound, by a sound receiver;
detecting atmospheric pressure, based on the ultrasonic signal;
determining whether a medium conveyance abnormality has occurred, based on the sound signal; and
modifying sensitivity of the sound receiver, correcting the sound signal, or modifying a criterion for determination of a medium conveyance abnormality, based on the atmospheric pressure.

6. A computer-readable, non-transitory medium storing a computer program, wherein the computer program causes a medium conveying apparatus including an ultrasonic transmitter capable of outputting an ultrasonic wave, an ultrasonic receiver opposed to the ultrasonic transmitter, to receive the ultrasonic wave and output an ultrasonic signal corresponding to the received ultrasonic wave, and a sound receiver to receive a sound and generate a sound signal corresponding to the received sound, thc program causcs thc medium to execute a process, the process comprising:
detecting atmospheric pressure, based on the ultrasonic signal;
determining whether a medium conveyance abnormality has occurred, based on the sound signal; and
modifying sensitivity of the sound receiver, correcting the sound signal, or modifying a criterion for determination of a medium conveyance abnormality, based on the atmospheric pressure.

7. The method according to claim 5, further comprising detecting temperature by a temperature sensor, wherein the atmospheric pressure is detected, further based on the temperature.

8. The method according to claim 5, further comprising detecting humidity by a humidity sensor, wherein the atmospheric pressure is detected, further based on the humidity.

9. The method according to claim 5, further comprising determining whether a multi-feed of a medium has occurred, based on the ultrasonic signal.

10. The computer-readable, non-transitory medium according to claim 6, the process further comprising detecting temperature by a temperature sensor, wherein the atmospheric pressure is detected, further based on the temperature.

11. The computer-readable, non-transitory medium according to claim 6, the process further comprising detecting humidity by a humidity sensor, wherein the atmospheric pressure is detected, further based on the humidity.

12. The computer-readable, non-transitory medium according to claim 6, the process further comprising determining whether a multi-feed of a medium has occurred, based on the ultrasonic signal.
